(19) United States
(12) Patent Application Publication
(10) Pub. No.: US 2006/0212905 A1
(43) Pub. Date: Sep. 21, 2006

(54) Broadcast receiving terminal and information processing apparatus

(75) Inventors: Masayuki Matsuda, Yokohama (JP); Hiroyuki Koreeda, Fujisawa (JP); Masaru Nanki, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/228,222

(22) Filed: Sep. 19, 2005

(30) Foreign Application Priority Data
Mar. 17, 2005 (JP) 2005-076240

(51) Int. Cl. H04N 5/445; G06F 13/00; G06F 3/00

(52) U.S. Cl. 725/51

(57) ABSTRACT

Upon reception of broadcast data which includes textual information or which is copyable, a broadcast receiving terminal presents the received data and a mark or a message by selecting which a user designates to paste/attach the received data into/to an e-mail. When the user selects the mark or the message, the broadcast data is pasted/attached into/to the e-mail which is to be transmitted.

This application claims the benefit of priority of Japanese Application No. 2005-76240 filed Mar. 17, 2005, the disclosure of which also is entirely incorporated herein by reference.

### TECHNICAL FIELD

The present invention relates to a broadcast receiving terminal and an information processing apparatus which are capable of receiving a broadcast.

### BACKGROUND

JP-A-2004-104640 discloses a TV receiver capable of storing data of a broadcast or a program with (broadcast data) a URL of a website and an e-mail address which are announced during the program is being broadcast. Meanwhile, JP-A-11-161584 discloses an electronic mailing system in which a URL included in a content of a received e-mail, if any, is automatically stored. This system allows a user to select any one of registered URLs so as to have a browser display a website related to the URL selected, or have a content of an e-mail including the selected URL displayed on the screen.

According to the above techniques, it is enabled that pieces of textual information included in a TV broadcast received, such as-URL and e-mail address, are automatically accumulated and a user can later utilize the accumulated information pieces. However, simply storing pieces of textual information one after another compels the user to search for a particular piece of information which the user wishes to use at a later time. Hence, there has been a demand for a method enabling the user to efficiently utilize received broadcast data. In addition, the user-friendliness in utilizing broadcast data during a broadcast is being viewed is required to be improved.

Thus, a broadcast receiving terminal and an information processing apparatus with improved user-friendliness are desired.

### SUMMARY

An aspect of the present invention resides in a broadcast receiving terminal which receives broadcast data. The broadcast receiving terminal displays the received data and a mark or a message, by selecting which a user designates to paste/attach the received data into/to an e-mail, when received broadcast data includes textual information or is data copyable. When the user selects the mark or the message, the broadcast data is pasted into or attached to an e-mail which is to be transmitted to a destination.

### BRIEF DESCRIPTION OF THE DRAWINGS

Embodiments of the present invention will be described in detail based on the following figures, wherein:

FIG. 1 is a block diagram showing a structure of a broadcast receiving terminal according to a first embodiment of the invention;

FIG. 2 is a flowchart illustrating an example of mail preparation processing executed with the terminal during a broadcast is viewed;

FIGS. 3A-3C show examples of screen displays of the broadcast receiving terminal;

FIGS. 4A and 4B show other examples of screen displays of the broadcast receiving terminal;

FIGS. 5A and 5B show further examples of screen displays of the broadcast receiving terminal;

FIG. 6 shows an example of a correspondence between keys and e-mail addresses; and

FIG. 7 shows preset key setting in a memory portion in the broadcast receiving terminal;

FIGS. 8A-8C show examples of screen displays of a broadcast receiving terminal according to a second embodiment.

### DETAILED DESCRIPTION

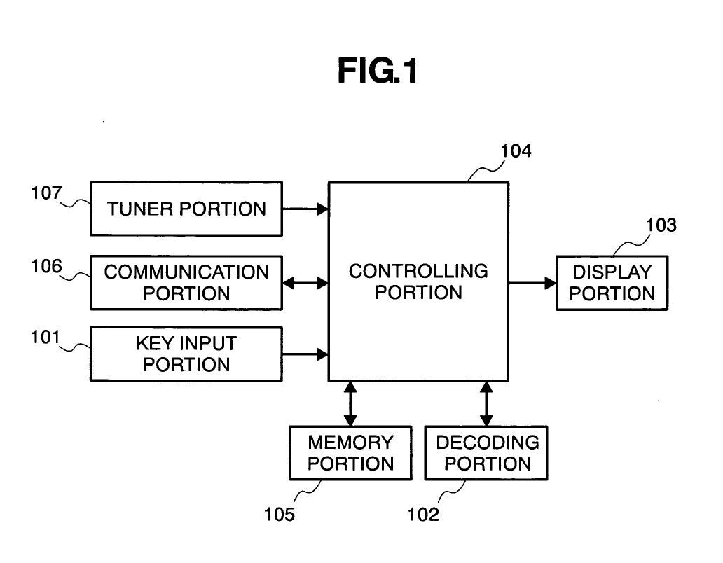

Referring first to FIG. 1, there is shown a broadcast receiving terminal according to a first embodiment of the invention. A key input portion 101 comprises numeric keys and function keys, through which a user can input information, such as letters and figures, and instructions. Although in the present embodiment the key input portion 101 is employed as an operating portion through which the user inputs instructions and others, the operating portion is not limited to the key input portion 101, but may be other devices such as audio input device and touch sensor. Where a plurality of manipulating methods are enabled in the terminal, the user can select a way of inputting instructions and others depending on how the user wishes to use the broadcast receiving terminal. A decoding portion 102 decodes textual information, image information, and audio information. A display portion 103 is a display device, e.g., a liquid-crystal display device, for presenting the textual information and image information as have been decoded, a pane for preparing an e-mail, and others. A controlling portion 104 comprises a processing device such as a CPU (Central Processing Unit), and operates to control each part or device in the broadcast receiving terminal based on instructions input through the key input portion 101 and in accordance with programs stored in a memory portion 105. The memory portion 105 stores various information including programs executed by the controlling portion 104, transmitted/received e-mails, incomplete e-mails under preparation, telephone numbers, and e-mail addresses. The memory portion 105 may comprise a memory IC or a hard disk, for instance. It is not essential, however, that the memory portion 105 is incorporated in the broadcast receiving terminal, but the memory portion 105 may be provided by a memory card removably attached, or an external memory device connected to, the receiving terminal, for instance. A communication portion 106 operates to transmit/receive information, in the form of e-mail, for instance. A tuner portion 107 is used to receive broadcast data, which is data representative of a broadcast.

The broadcast data includes textual information in addition to the image and audio information. The textual information includes broadcast information and subtitle information. The broadcast information may include, for instance: the name of the broadcast; the cast or the names of performers appearing in the broadcast; and link information which allows a view of the broadcast to visit a web site of the broadcast. The subtitle information may consist of information related to a content of the broadcast, and/or information not directly related to the content of the broadcast. The former information may include subtitles where the broadcast is a drama program. The latter information may be heavy rain warning or earthquake information, for example. Meanwhile, the image information may be data of compressed format, such as MPEG (Moving Picture Experts Group) data.

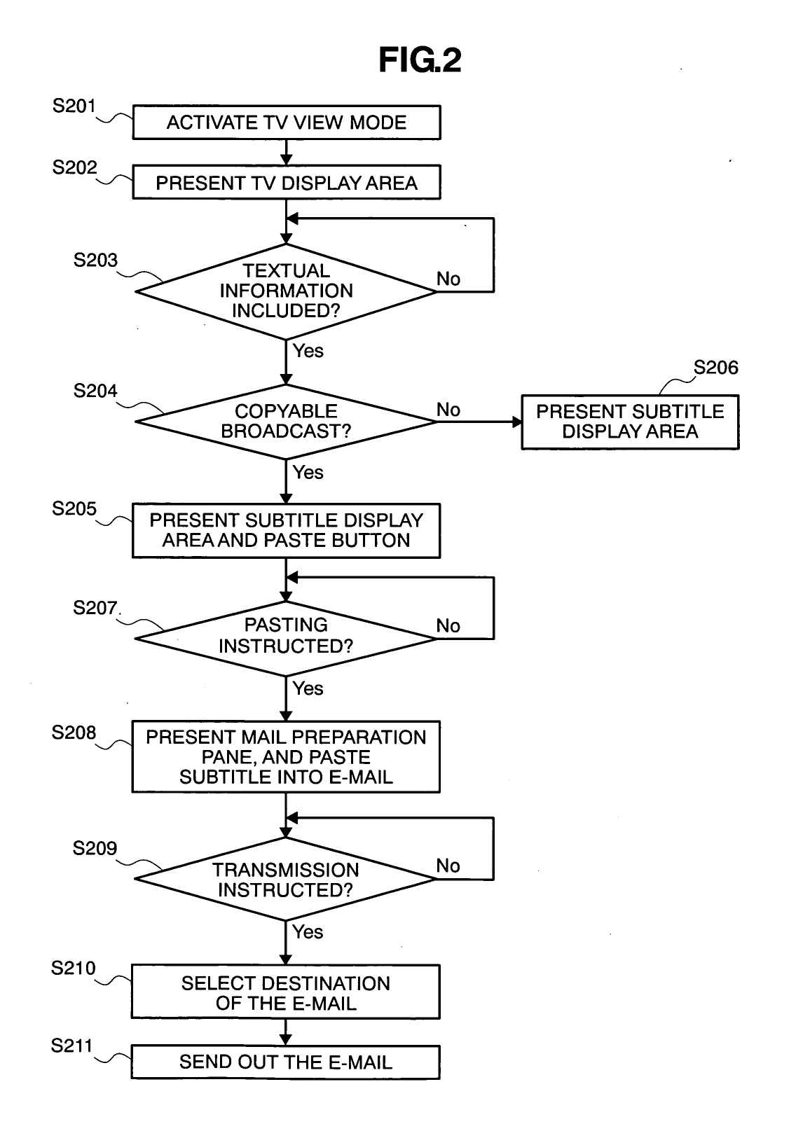

FIG. 2 is a flowchart illustrating an example of mail preparation processing which is executed by the controlling portion 104 in accordance with a control program stored in the memory portion 105 while a broadcast is viewed. It is not essential that this control program is stored in the memory portion 105, but it may be arranged such that the user of the terminal installs this control program after purchasing the terminal.

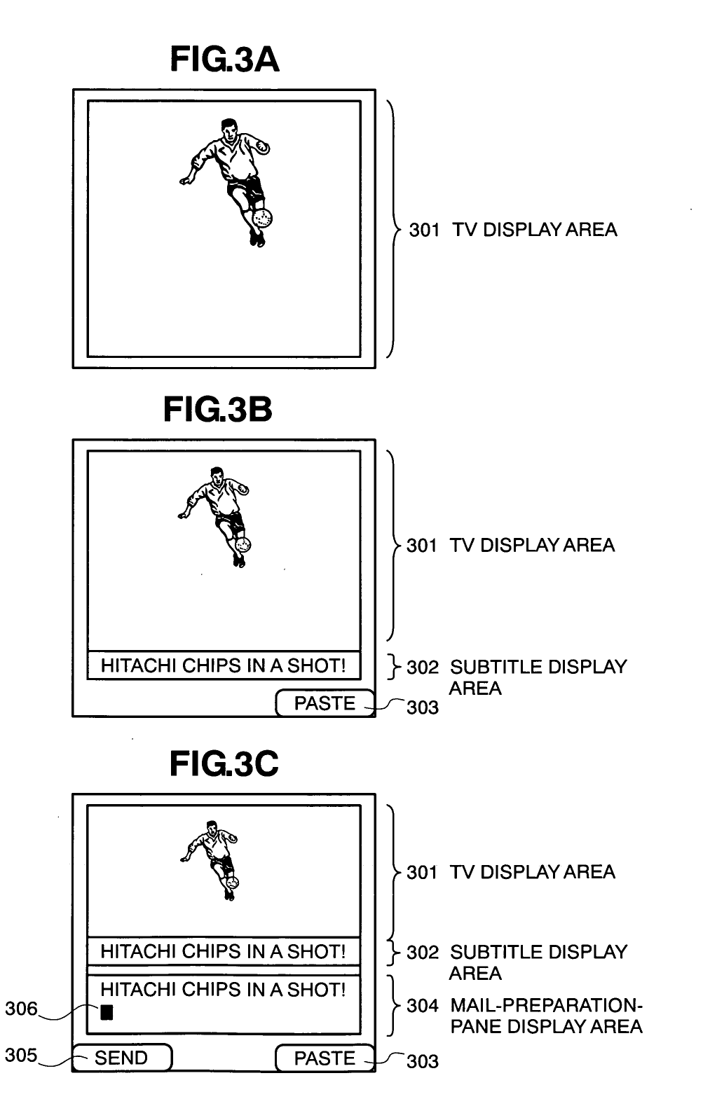

The processing flow initiates with step S201, when the user sets an operation mode of the terminal at TV VIEW mode by manipulating the key input portion 101. The flow then goes to step S202 to present, on a screen of the display portion 103, a TV display area 301 in which an image of the broadcast as decoded by the decoding portion 102 is displayed, as shown in FIG. 3A.

The flow then goes to step S203 to determine whether the broadcast data includes textual information or not. Where textual information is included, the flow goes to step S204 to further determine whether the broadcast data is copyable or not. That is, in some cases, broadcast data received by the terminal is attached with copy limit information which designates a degree of allowance for storing the broadcast data. For instance, the copy limit information may indicate that the received information, i.e., the broadcast data, is of one of the following three types: “Copy Free”, namely, copying of the broadcast data is permitted as many times as desired; “Copy Once”, namely, one generation copying of the broadcast data is permitted; and “Copy Never”, namely, copying the broadcast data is completely inhibited. Broadcast data of the “Copy Free” type can be stored in the terminal and further outputted to an external device from the terminal. For instance, broadcast data of the type can be initially stored in the terminal, and then transmitted to a destination by being attached to an e-mail, or to a memory removably attached to the terminal. Broadcast data of the “Copy Once” type can be stored in the terminal, but can not be transmitted to an external device. Broadcast data of the “Copy Never” type can be neither stored in the terminal nor transmitted to a destination and an external device.

Where an affirmative decision is made in step S204, that is, where it is determined that the received broadcast data is not attached with the copy limit information, or that the received broadcast data is attached with information indicative of that the broadcast data is copyable once or more, the flow goes to step S205 to reduce the size of the TV display area as shown in FIG. 3B, and present, on the screen, a subtitle display area 302 in which is displayed a subtitle decoded by the decoding portion 102, and a “PASTE” button 303 which is to be selected by the user when a subtitle is desired to be pasted into a body of an e-mail.

When a subtitle is displayed in the subtitle display area 302, character or text data representative of the subtitle as decoded is stored in the memory portion 105.

The text data stored in the memory portion 105 may be in the JIS code, which defines a correspondence between graphic characters and combinations of bits. Alternatively, the text data may be in a bitmap format in which the text data is displayed on the screen.

On the other hand, where a negative decision is made in step S204, that is, where the broadcast data is of the “Copy Never” or “CopyOnce” type, the PASTE button 303 is not presented when the subtitle display area 302 is presented on the screen in step S206. The above arrangement where the PASTE button 303 is presented only when there is textural information available for an e-mail prepared, protects copyrights of broadcast data, and enable to inform the user of non-availability of broadcast data for an e-mail prepared, where appropriate. However, the control in the case where the received broadcast data is of the “Copy Never” or “Copy Once” type is not limited to such as described above, but may be modified. For instance, it may be arranged such that even when broadcast data of the “Copy Never” or “Copy Once” type is received, the PASTE button is presented, in the same way as in the case where the “Copy Free” type data is received, and when the PASTE button is selected, a message indicating that the textual information is not permitted to be pasted, e.g., “NOT ALLOWED TO BE PASTED”, is presented. Alternatively, it may be arranged such that a message indicating that the textual information is not permitted to be pasted, e.g., “PASTING INHIBITED”, is presented in replacement of the PASTE button. It may be arranged such that in the case of broadcast data of the “Copy Once” type, when pasting of a subtitle is instructed by the user, a message such as “IF YOU TRANSMIT THE BROADCAST DATA, THE DATA IS DELETED FROM THE TERMINAL. DO YOU PROCEED?” is presented, and when the user inputs a request for transmission, the data is deleted from the terminal and an e-mail in which the data is pasted is sent out.

Where the broadcast data is transmitted in parts which are sequentially received by the terminal, and when textual information is included in some or all of the parts of the broadcast data, the subtitle presented in the subtitle display area 302 is sequentially updated to the subtitle last received, although not shown in the flowchart of FIG. 2. In the present embodiment, whether or not textual information is included in the last received part of the broadcast data, the subtitle display area is kept presented on the screen. However, the control may be modified as follows. When textual information has not been newly received for a predetermined period of time, e.g., five minutes, the subtitle display area disappears and the TV display area is enlarged. By this control method, the user can view the image in a larger area when there is no textual information.

In the present embodiment, the subtitle display area is not provided where the broadcast data does not include textual information, in order to have the TV display area as large as possible. However, the display may be otherwise. For instance, upon activation of the TV VIEW mode the subtitle display area is presented on the screen, together with the TV display area, irrespective of presence/absence of the textual information. Alternatively, it may be arranged such that the image and the subtitle are not presented in respective areas separate from each other, but the image and the subtitle are presented in a single display area such that the subtitle is superimposed on the image.

Referring back to the flow chart, when it is determined in step S204 that the received broadcast data is copyable and the user manipulates the key input portion 101 to select the PASTE button 303 in step S207, the flow goes to step S208 to present a display area 304 for a mail preparation pane (which will be referred to as “the mail-preparation-pane display area” hereinafter) on the screen, as shown in FIG. 3C, display the subtitle in the mail-preparation-pane display area 304, and present a “SEND” button 305. As shown in FIG. 3C, in this step S208, an indicator 306 indicating the position wherefrom a sentence is to be added is presented in the mail-preparation-pane display area 304 and after the pasted subtitle. That is, continuing from the pasted subtitle, and from the position where the indicator is presented, a message can be additionally written or another subtitle in the subtitle display area 302 can be pasted. In a case where the size of the characters of the subtitle as presented in the subtitle display area 302 and the size of the characters in the mail preparation pane differ, the former size is changed to be the same as the latter size.

The control flow then goes to step S209 to determine whether the SEND button 305 is selected. When an affirmative decision is made in step S209, the flow goes to step S210 to read a list of mail addresses stored in the memory portion 105 and present the list on the screen of the display portion 103 so that the user can select a destination of the e-mail from the list. The flow then goes to step S211 to send out the prepared e-mail by means of the communication portion 106.

As described above, this embodiment enables to use, the textual information included in the broadcast data for an e-mail by the simple manipulation, while the broadcast is being viewed, thereby improving the user-friendliness of the terminal.

It is noted that although in the present embodiment the user instructs to paste the subtitle into an e-mail by manipulation of the key input portion 101, the instruction may be made otherwise. For instance, in a case where the broadcast receiving terminal is of the type with two main body parts which are slidable relative to each other, it may be arranged such that when the user opens the terminal by sliding the two main body parts relative to each other while viewing a broadcast with the terminal closed, this sliding, relative movement of the main body parts is recognized by the controlling portion 104 as the instruction to paste. In a case where the broadcast receiving terminal is of the folding type, an action of the user to fold-open the terminal from its fold-closed state may be recognized as the instruction to paste. An arrangement where opening/closing of the terminal by a sliding, folding or like action of the user is recognized as the instruction to paste enables to omit manipulation of the keys in making the instruction, thus simplifying the action necessary to make the instruction. The broadcast receiving terminal may be equipped with a timer, so that a sentence in the subtitle display area can be automatically pasted into an e-mail when the time reaches a value preset by the timer. This arrangement facilitates use of information which is broadcast everyday at a scheduled time, such as news and whether forecast, in preparing an e-mail.

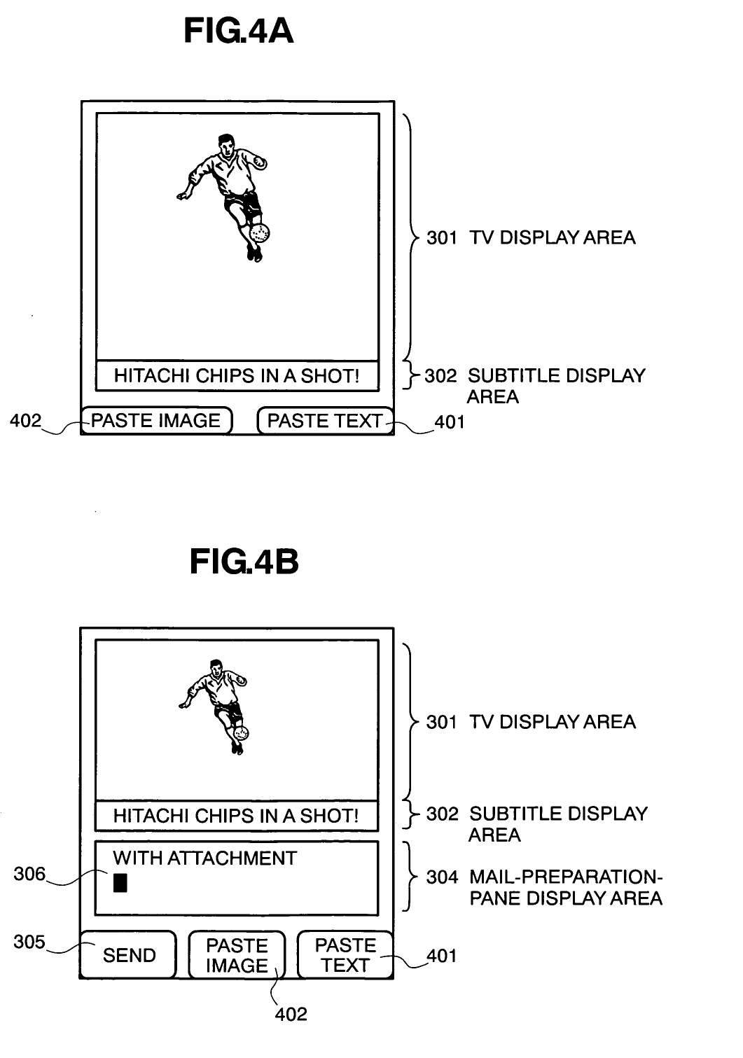

Although there has been described, for illustrative purpose only, the embodiment where the textual information is pasted into an e-mail, the information pasted into or attached to an e-mail may not be limited to the textual information, but the image information may be pasted into or attached to an e-mail. For instance, upon activation of the TV VIEW mode, a “PASTE TEXT” button 401 and a “PASTE IMAGE” button 402 may be presented together with the TV display area 301 and the subtitle display area 302, on the screen, as shown in FIG. 4A. When the PASTE IMAGE button 402 is selected in this screen, the image currently presented in the TV display area 301 is stored as a still image, the stored still image is attached to an e-mail, and a message indicting that the e-mail is with attachment is entered within the mail preparation pane, as shown in FIG. 4B. By seeing the message entered, the user can confirm that data of the still image is attached to the e-mail. The data of the still image may be data of an image as presented in the display area 301 and in the form of a BMP file. Alternatively, the data of the still image maybe compressed into the form of a JPEG file. When the image data is compressed into a format such as JPEG, the broadcast receiving terminal may be equipped with hardware exclusively for creating compressed files so as to improve the speed of compressing image data.

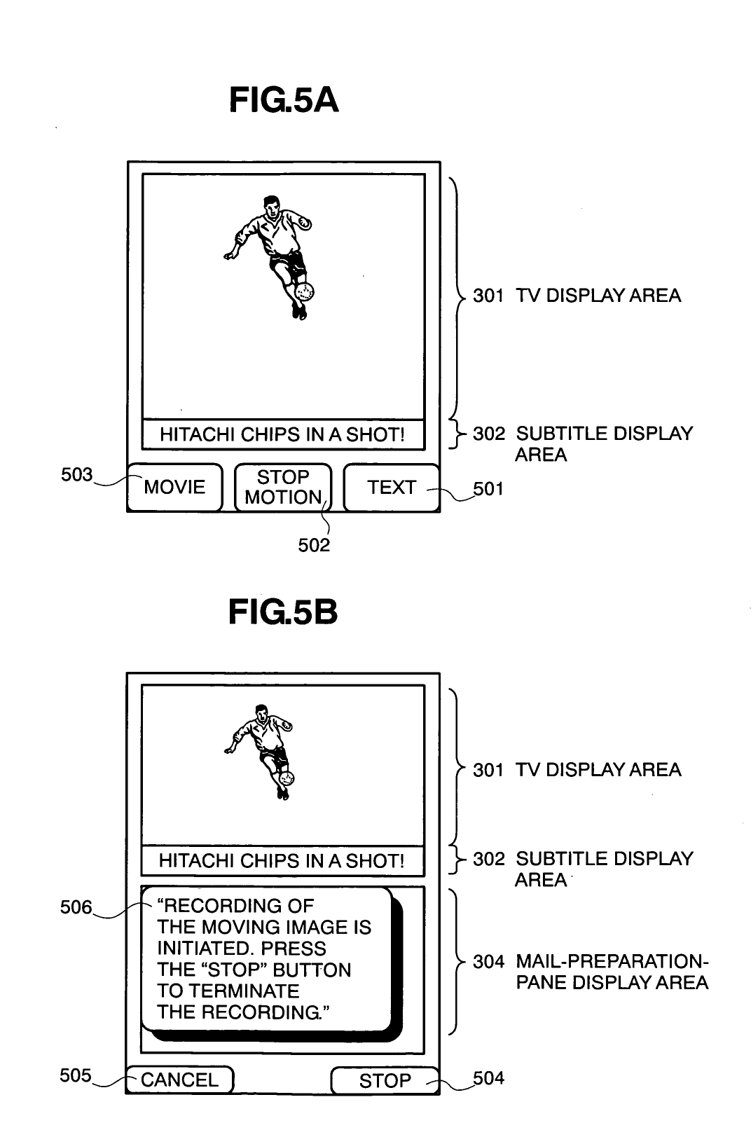

The image information to be attached is not limited to the still image but may be moving image. There will be described the case where a moving image is attached to an e-mail. Upon activation of the TV VIEW mode, a “TEXT” button 501, a “STILL IMAGE” button 502, a “MOVING IMAGE” button 503, which represent kinds of information attachable to e-mail, are presented on the screen, as shown in FIG. 5A. When the user selects the MOVING IMAGE button 503, recording of the moving image is initiated, and a message such as “RECORDING OF THE MOVING IMAGE IS INITIATED. PRESS THE “STOP” BUTTON TO TERMINATE THE RECORDING.” is presented, as shown in FIG. 5B. This message may be presented for several seconds, or kept presented until the STOP button 504 is selected. Data of the moving image is stored in the form of compressed image data such as MPEG file, in the memory portion 105. When the STOP button 504 is selected, a screen display, such as one shown in FIG. 4B for instance, is presented. When the “SEND” button 305 shown in FIG. 3C is selected, an e-mail whereto the moving image is attached is sent out. On the other hand, when a “CANCEL” button 505 is selected, the screen returns to the screen display of FIG. 5A.

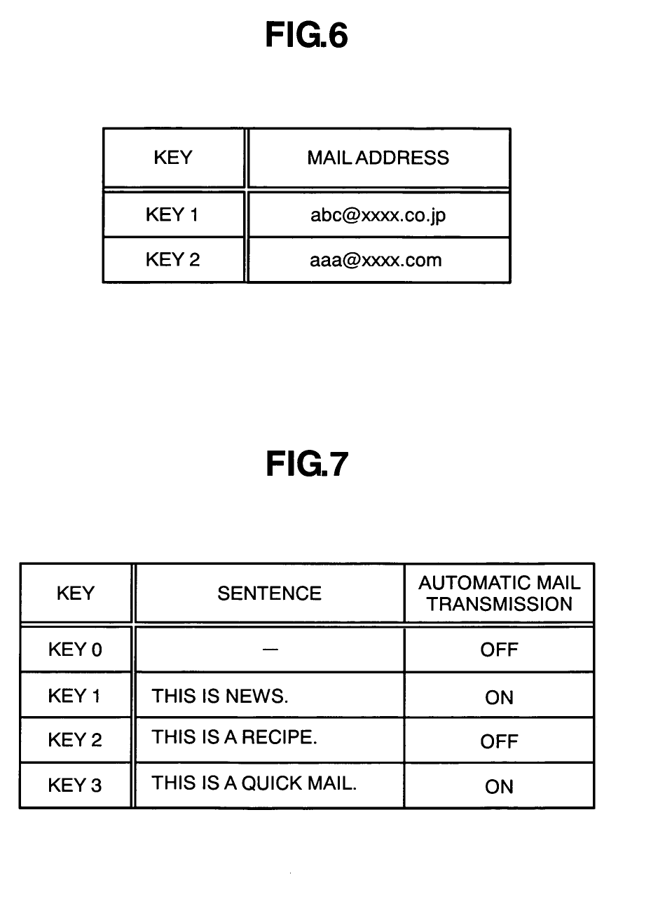

According to the above arrangement where data of a moving image of a broadcast is attached to an e-mail and forwarded to a destination, even where a device as the destination of the e-mail can not receive the broadcast, transmission of information of the broadcast to the destination device is easily made by the attaching the image information to the e-mail. On the contrary, it is difficult to illustrate the information only with text. It may be arranged such that when the “MOVING IMAGE” button 503 is selected, audio information as well as the image information are recorded and attached to an e-mail to be transmitted. In the above-described embodiment, when the SEND button 305 is selected, the list of mail addresses stored in the memory portion 105 is presented on the screen of the display portion 103 so that the user can select a destination from the list. However, the way of selecting the destination is not limited to this. For instance, it may be arranged such that mail addresses are beforehand stored as destinations each associated with one of the numeric keys of the key input portion 101, as shown in FIG. 6, so that the user can select a mail address as the destination of an e-mail by simply pressing the key associated therewith. According to this arrangement, when selecting the destination, it is not required to present the address list on the screen of the display portion 103 and thus the user is not interrupted from viewing the broadcast, facilitating the selection of the destination. For instance, every time a numeric key “1” is pressed, mail addresses are presented one by one, in order of frequency of use, in order of the Japanese syllabary, or in alphabetical order, that is, mail addresses are presented in the following sequence, for instance: “aaa@xxxx.com”, “abc@xxxx.co.jp”, . . . . Although in this embodiment the destination of the e-mail is designated after the SEND button 305 is selected, the way of designating the destination is not limited to this. For instance, the destination of the e-mail may be designated after the PASTE button is selected. Further, it may be arranged such that a destination to which an e-mail is to be transmitted during a broadcast is viewed is registered before the viewing of the broadcast, and the e-mail is sent out to the registered destination upon selection of the SEND button 305. By beforehand registering the destination in such a way, it is not necessary to select a mail address during the broadcast is viewed, thereby allowing the user to view the broadcast without interruption and to sent out the e-mail easily.

In the above-described embodiment, upon the selection of the PASTE button 303, the mail-preparation-pane display area 304 is presented on the screen. However, the control may be otherwise executed. Since presenting the mail-preparation-pane display area on the screen narrows the TV display area, deteriorating the view of the broadcast, it is preferred to allow the user to choose between a mode in which the mail-preparation-pane display area is presented on the screen, as shown in FIG. 3C for example, and another mode in which the mail preparation pane is not presented.

In the above-described arrangement where it is selectable whether the mail preparation pane is presented or not, when the user chooses the mode not to present the mail preparation pane and manipulates one of the keys after the PASTE button is selected, words or a sentence associated with the manipulated key is added to a body of an e-mail which is then transmitted. For instance, as shown in FIG. 7, each numeric key of the key input portion 101 is associated with a sentence and information as to whether an e-mail in whose body the sentence is added is to be transmitted immediately after that key is pressed, which information will be referred to as “an automatic transmission setting”. For instance, it may be arranged such that when the PASTE button is selected and the numeric key “1” is pressed while a message “An earthquake has occurred just now.” is presented in the subtitle display area, a sentence associated with the numeric key “1”, namely, “THIS IS NEWS.”, is introduced into a body of an e-mail, so that there is prepared an e-mail whose body reads “THIS IS NEWS. An earthquake has occurred just now.” In the example of FIG. 7, the numeric key “1” is associated with information that the e-mail prepared with pressing of this key should be sent out immediately after the pressing, that is, the automatic transmission setting for the numeric key “1” is “ON”, and thus the prepared e-mail is automatically sent out immediately after the pressing of the numeric key “1”.

When a numeric key “2” is pressed while a message “Measure 10 g sugar and set aside.” is presented in the subtitle display area, an e-mail whose body reads “THIS IS A RECIPE. Measure 10 g sugar and set aside.” is prepared. Since the automatic transmission setting for the numeric key “2” is “OFF”, the prepared e-mail is not sent out immediately, but is once stored in the memory portion 105, and the controlling portion 104 waits for the next instruction keyed in. Thereafter, when the PASTE button is selected while a message “Next, measure 50 g flour and set aside. ” is presented in the subtitle display area, this subtitle or message is added to the body of the e-mail, so that the body now reads “THIS IS A RECIPE. Measure 10 g sugar and set aside. Next, measure 50 g flour and set aside.” Then, when a numeric key “0” is pressed, or the SEND button is selected, the prepared e-mail is sent out.

According to the above arrangement where the mode not to present the mail preparation pane is selectable, the user can transmit an e-mail easily without being interrupted from viewing the broadcast. If a user as a sender transmits only a part of broadcast data, e.g., subtitles, by attaching the part of the broadcast data to an e-mail, another user receiving the e-mail with the attachment may not comprehend the content of the e-mail or the intention of the sender. On the other hand, in the above-described example, since the broadcast data can be transmitted with a simple message such as “THIS IS NEWS. ”, the user-friendliness is improved. In the example of FIG. 7, sentences are associated with the respective keys, but in place of the sentences, or in addition to the sentences, another information to be added to e-mail, such as subject name of e-mail, may be registered in association with the keys. Although there has been illustrated, by referring to FIG. 7, the arrangement where pressing a key adds textual information associated with that key to the body of an e-mail, this arrangement is applicable to the case where the information attached to or pasted into an e-mail is image information and not textual information, as described above.

There has been described the case where the textual or image information is transmitted by being attached to or pasted into an e-mail. However, the textual or image information may be transmitted by another means. For instance, the textual or image information may be transmitted through chat functionality, and not by means of e-mail, so that the broadcast information can be transmitted to a receiver in real time.

Although there has been described, with reference to FIGS. 1 to 7, the case where an e-mail is prepared using broadcast data received during a broadcast is being received, the control may be otherwise. For instance, an e-mail may be prepared such that first MAIL PREPARATION mode is activated, and broadcast data is used while an e-mail is being prepared. There will be described a broadcast receiving terminal according to a second embodiment of the invention, where such a method is employed, that is, textual information is received during an e-mail is being prepared, the textual information is presented on a screen of a display portion of the terminal, and the textual information is used for the e-mail prepared.

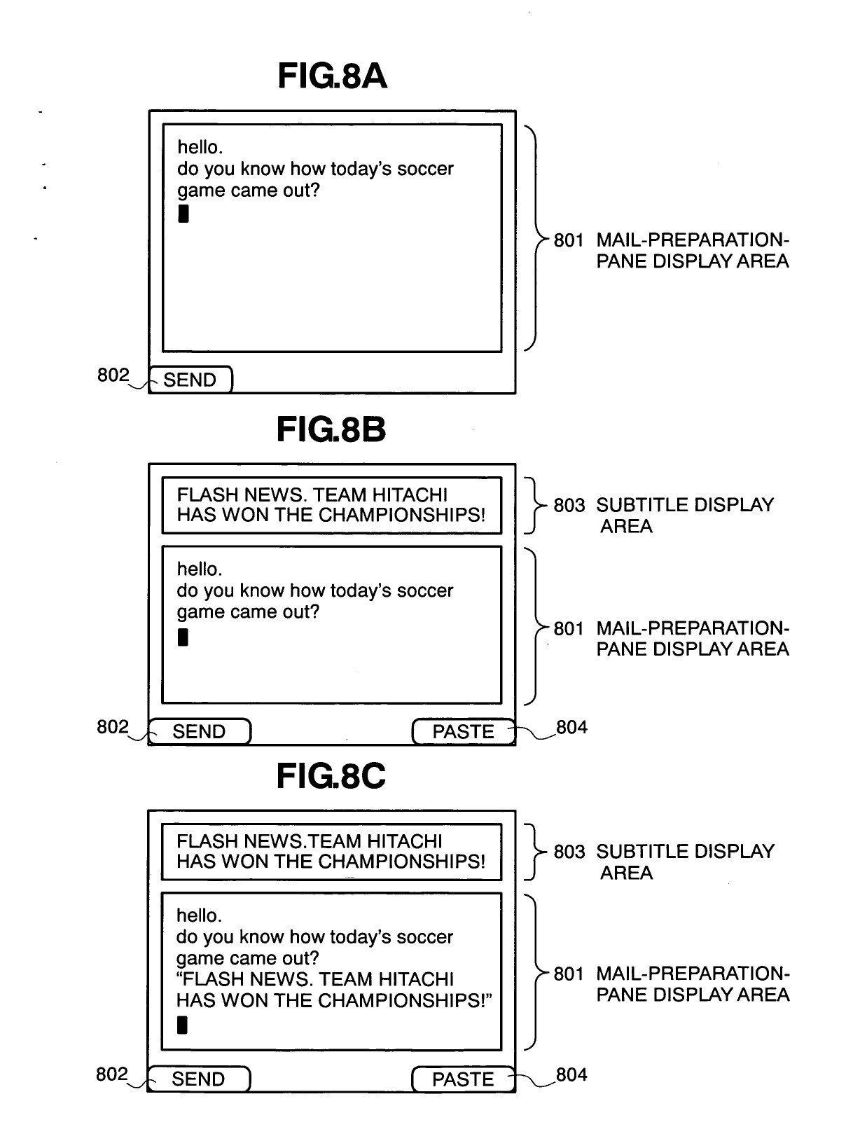

Upon the MAIL PREPARATION mode is activated by a user, a mail-preparation-pane display area 801 is presented on a screen of a display portion 103, as shown in FIG. 8A. When broadcast data including textual information is received while the user is preparing an e-mail, a subtitle display area 903 is presented as shown in FIG. 8B to display the textual information received. Upon selection of a PASTE button 804 by the user, the textual information is pasted into the e-mail, as shown in FIG. 8C.

In this way, even while preparing an e-mail, the user can see information such as flash news as soon as the information occurs, and easily use the information for the e-mail.

In some cases, the user may feel bothered when all the received textual information is presented. Thus, it is desirable that predetermined information is selectively extracted from the received textual information and only the extracted information is presented on the screen. For instance, the user in advance registers keywords such as “soccer” and “news flash”, and when a piece of textual information related to any of the keywords is received, a subtitle display area is presented on the screen of the display portion 103 to display the piece of textual information there. In this way, information the user is interested can be presented. Further, keywords may be registered in association with destination mail addresses. For instance, where the user registers a keyword such as favorite pursuit or occupation of a particular receiver in association with that receiver, information useful for the receiver can be added to an e-mail.

The second embodiment may be modified such that on the screen are presented a subtitle display area 903, a “BROADCAST” button, and an “AUDIO” button. The user can instruct to output images and sounds of broadcast data by pressing the BROADCAST button, and to output only sounds by pressing the AUDIO button. This arrangement enables the user to view a broadcast without complex manipulation when the user becomes interested in the broadcast while seeing a subtitle of the broadcast. It may be arranged such that when a particular kind of information such as emergency notification is received, a TV display area is automatically presented so that image information as well as audio information are outputted in addition to textual information. Further, it may be arranged such that upon presentation of textual part of information, audio part of the information is also automatically outputted for only a predetermined period of time, e.g., 30 seconds, so that the user can learn further details of the information.

According to each of the embodiments described above, the received broadcast data can be efficiently utilized, improving the user-friendliness. Thus, a broadcast receiving terminal and an information processing apparatus with improved user-friendliness are provided.

The foregoing invention has been described in terms of preferred embodiments. However, those skilled, in the art will recognize that many variations of such embodiments exist. Such variations are intended to be within the scope of the present invention and the appended claims.

What is claimed is:

1. A broadcast receiving terminal having a display, the terminal comprising:
a receiver which receives broadcast data;
a controller which operates to present, when textual information is included in the broadcast data received by the receiver, the textual information and a mark or a message, in the display, and to prepare an e-mail using the textual information when the user selects the mark or the message; and
a communication portion capable of transmitting the prepared e-mail.

2. The broadcast receiving terminal according to claim 1, further comprising a memory which stores a keyword, and wherein the textual information presented in the display is information associated with the keyword stored in the memory.

3. The broadcast receiving terminal according to claim 1, wherein the textual information presented in the display is copyable.

4. The broadcast receiving terminal according to claim 1, wherein the controller operates to present the prepared e-mail when the user selects the mark or the message.

5. The broadcast receiving terminal according to claim 1, wherein the controller does not present the mark nor the message in the display when the broadcast data received by the receiver does not include textual information.

6. The broadcast receiving terminal according to claim 1, wherein the mark is a button which is selected to paste the textual information into the e-mail.

7. A broadcast receiving terminal comprising:
a receiver which receives broadcast data;
a display capable of presenting at least a part of the broadcast data received by the receiver;
a controller which operates to present a mark or a message in the display when the broadcast data received by the receiver is copyable, and to paste/attach the broadcast data into/to an e-mail when the user selects the mark or the message; and
a communication portion which transmits the e-mail into/to which the broadcast data is pasted/attached.

8. An information processing apparatus comprising:
a transmitter capable of transmitting data;
a receiver capable of receiving data;
a display capable of presenting at least a part of the data received by the receiver; and
a controller which operates to present a mark or a message in the display when the data received by the receiver is copyable, and to generate data into/to which at least a part of the data presented in the display is pasted/attached, and transmit the generated data by the transmitter when the user selects the mark or the message.

9. The information processing apparatus according to claim 8, wherein the data presented in the display is textual information.

10. The information processing apparatus according to claim 8, further comprising a memory which stores a keyword, and wherein the data presented in the display is information associated with the keyword stored in the memory.

11. The information processing apparatus according to claim 8, wherein the controller does not present the mark nor the message when the data received by the receiver is not copyable.
